(19) United States
(12) Patent Application Publication
(10) Pub. No.: US 2022/0122184 A1
(43) Pub. Date: Apr. 21, 2022

(54) Document Monitoring, Visualization, and Error Handling

(71) Applicant: SAP SE, Walldorf (DE)

(72) Inventors: Jing Jing, Shanghai (CN); Chunyan Xu, Shanghai (CN); Xiaotao Ren, Shanghai (CN); Chunxia Bi, Shanghai (CN); Junjie Ge, Shanghai (CN); Wenjie Jin, Shanghai (CN)

(21) Appl. No.: 17/075,214

(22) Filed: Oct. 20, 2020

(51) Int. Cl. G06Q 40/00; G06F 40/194; G06N 20/00

(52) U.S. Cl. CPC G06Q 40/10; G06N 20/00; G06F 40/194

(57) ABSTRACT

Embodiments offer monitoring, visualization, and/or error handling for large volumes of electronic documents. A document handling system may visualize documents in other than table format (e.g., a flow chart view presenting documents in the context of a process for which they are created and used). Certain embodiments may provide automated recognition of document errors based upon classification of error types. Such monitoring may involve grouping documents together according to error type. This allows efficient correction of errors in grouped documents, rather than requiring the user to correct each document individually. Specific embodiments may further provide suggestions of solutions for error correction. Such intelligent recommendation can be based upon supervised learning models trained with data corpuses of prior correction efforts involving compliance with legal requirements and/or internal guidelines. The models can involve breaking down error messages into themes and corresponding keywords, and determining similarities.

### BACKGROUND

Unless otherwise indicated herein, the approaches described in this section are not prior art to the claims in this application and are not admitted to be prior art by inclusion in this section.

Documents useful in the operation of enterprises are increasingly being handled electronically. However, complex processes such as identifying errors in electronic documents, and then correcting those errors, may still be handled in a manual fashion, on a document-by-document basis. This can lead to inefficiency, inaccuracy, and increased cost.

Moreover, the manner of handling of electronic documents can be governed at least in part by local, regional, and/or national laws. For example, in South Korea electronic invoicing of tax documents is mandatory as a legal requirement.

### SUMMARY

Accordingly, embodiments relate to methods and apparatuses for monitoring, visualization, and error handling of electronic documents. Particular embodiments interact with an existing electronic document system, e.g., one that presents documents in strictly tabular form for visualization and handling. The instant document handling system is configured to present a visualization of the available documents in other than table format. In one example, electronic documents may be visualized in a flow chart view allowing their presentation within the process for which they are used and created.

Certain embodiments may further provide for the automated recognition of errors within documents, and the classification of error types. This in turn permits grouping of documents according to common error types. Such monitoring then allows for the rapid and efficient correction of errors in grouped documents, rather than requiring the user to address correction of each document on an individual basis.

Specific embodiments of electronic document handling systems may also go further, providing suggestions of solutions for error correction. Such intelligent recommendation can be based upon supervised learning models trained with data corpuses reflecting prior correction efforts, and/or rules governing compliance with internal guidelines and/or legal requirements.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a screen shot of a flow chart view according to an example.

FIG. 4 shows the classification of electronic documents with errors.

FIG. 5 is a simplified screen show showing customers having a common document error.

FIG. 6 is a simplified interface screen providing error correction solutions.

FIG. 7 is a simplified flow diagram of an overview of error analysis according to an exemplary embodiment.

FIG. 8 is a simplified flow diagram showing the handling of different log types.

FIGS. 9A-B show tables used in the classification of error messages from application logs.

FIGS. 10A-B show tables used in the classification of error message from interface logs.

FIG. 11 shows a simplified view of an exemplary architecture for performing analysis of external errors.

FIG. 12 illustrates hardware of a special purpose computing machine according to an embodiment that is configured to implement handling of electronic documents.

FIG. 13 illustrates an example computer system.

### DETAILED DESCRIPTION

Described herein are methods and apparatuses that implement electronic document handling. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

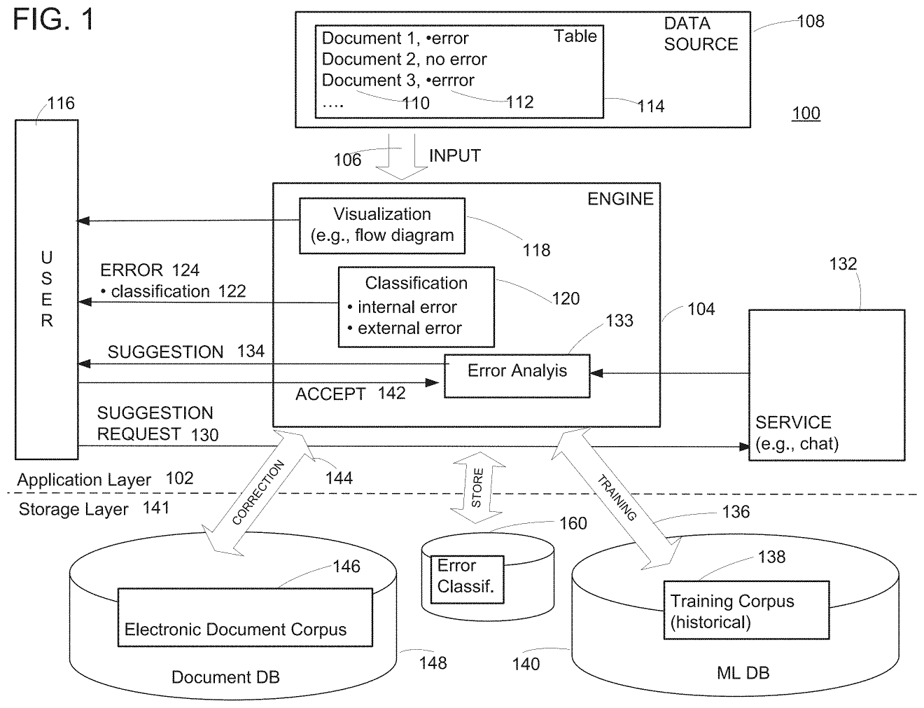

FIG. 1 shows a simplified view of an example system that is configured to implement electronic document visualization, monitoring, and error correction according to an embodiment. Specifically, system 100 comprises an application layer 102 which includes a processing engine 104.

The processing engine is configured to receive an input 106 from a data source 108. As discussed in detail below, one example of a data source is the Document Compliance solution available from SAP SE of Walldorf, Germany.

The input may comprise document information 110 together with any error information 112 (e.g., as may be available from an error log). A variety of different types of documents and of document errors, may exist.

In the specific example relating to the SAP Document Compliance (DC) solution, documents from the data source can include Enterprise Resource Planning (ERP) billing invoices/Accounts Receivable (AR) invoices. According to the exemplary scenario, a SAP DC solution may create a specific electronic document (e.g., eInvoice) for each billing or Accounts Receivables (AR) invoice which needs to be transformed for ultimate submission to a national tax authority (e.g., the taxation branch of South Korea).

In various embodiments the eInvoice document may be slated for direct or indirect submission to the South Korean tax authority. Such a Business-to-Government (B2G) transfer is as between business and government, for example transferring the eInvoice to a tax authority directly, or transferring the eInvoice to a tax authority indirectly via 3rd party agencies who are authorized by the government for this role.

Information contained in such an eInvoice may include one or more of:

supplier/buyer master data,

invoice header amount, or

item amount.

An electronic document may also include additional information specific for its use. For example, the eInvoice according to the example may include one or more of:

invoice type,

supplier/buyer tax registration number,

eInvoice donate mark.

As illustrated by the eDocument/eInvoice example, various types of document errors may exist. As described later in connection with that example, document errors may be internal or external in nature, e.g.:

“missing mandatory information”—an internal error checked by the SAP Document Compliance solution;

“process action error”—an internal error checked by the SAP Document Compliance solution;

“communication error”—internal error;

“response error from external system”—external error.

Further details regarding these particular errors are given in the example later below.

The electronic document information and error information may be available as a simple table 114 in the data source. However, other than indicating the mere existence of an error, such a table may contain little or no additional information to assist a user 116 in analyzing and correcting the errors.

Accordingly, the processing engine is configured to receive the input from the data source, and to construct a visualization 118 therefrom. As described in detail below, this visualization may comprise other than a table, for example a flow diagram depicting the documents within a process involving their creation and handling.

Such a visualization of electronic documents may reflect an execution sequence (e.g., lifecycle) of the documents from the data source. The visualization may also include error information regarding the documents. This visualization can aid the user in intuitive understanding of a set of electronic documents, and possible errors associated therewith.

In particular, certain documents may share common errors. Accordingly, the processing engine is further configured to perform error classification 120. This error classification can recognize and determine a classification 122 for various occurrences of document errors 124. The error classification is stored in a database 160.

At a high level, error classification may be able to distinguish between internal errors and external errors. Internal errors arise from known requirements that are imposed by the internal system—e.g., missing fields or improper formatting in the data source.

By contrast, external errors arise from requirements imposed from outside of the internal system. Examples can include legal regulations imposed by particular jurisdictions. Such external errors are not typically known in advance, and may require analysis for effective recognition and classification.

At a lower level, the error classification may be able to group different documents according the type of errors present therein. For example, multiple documents could all have the same error of missing master data.

Accordingly the processing engine may be further configured to perform error analysis 133 upon classes of errors that are present. Thus based upon communicated error class information, the user may be prompted to request 130 that the processing engine provide a suggestion of a solution for correcting the error. As shown in FIG. 1, this suggestion request may be communicated to the processing engine via a service 132 such as a chat service.

Upon receipt of the request for suggestion, the processing engine performs error analysis 133 to result in a suggestion 134 of a solution for correcting the error. That error analysis may involve execution of a model that has been trained 136 from a corpus 138 of historical error correction data. That training corpus may be stored in a non-transitory computer readable storage medium 140 within storage layer 141.

Upon user acceptance 142 of the suggestion, the processing engine can implement actions to correct 144 errors of an electronic document corpus 146 that is present in a non-transitory computer readable storage medium 148. Correction of errors sharing the same classification can be made to multiple documents, thereby streamlining the amount of effort involved and reducing cost.

Embodiments as described herein, can offer certain benefits. Document handling systems may be used to identify and resolve electronic document efficiently, using automated error classification and intelligent solution recommendation. The implementation of particular embodiments helps enterprises stay compliance in terms of electronic document handling requirements, improved process efficiency, and reduction in costs.

Embodiments reduce the time that users take to identify and fix errors. The document handling systems can transform the user experience by proactively classifying errors, providing error solutions, and learning from user behavior in order to provide more intelligent suggestions for correcting errors.

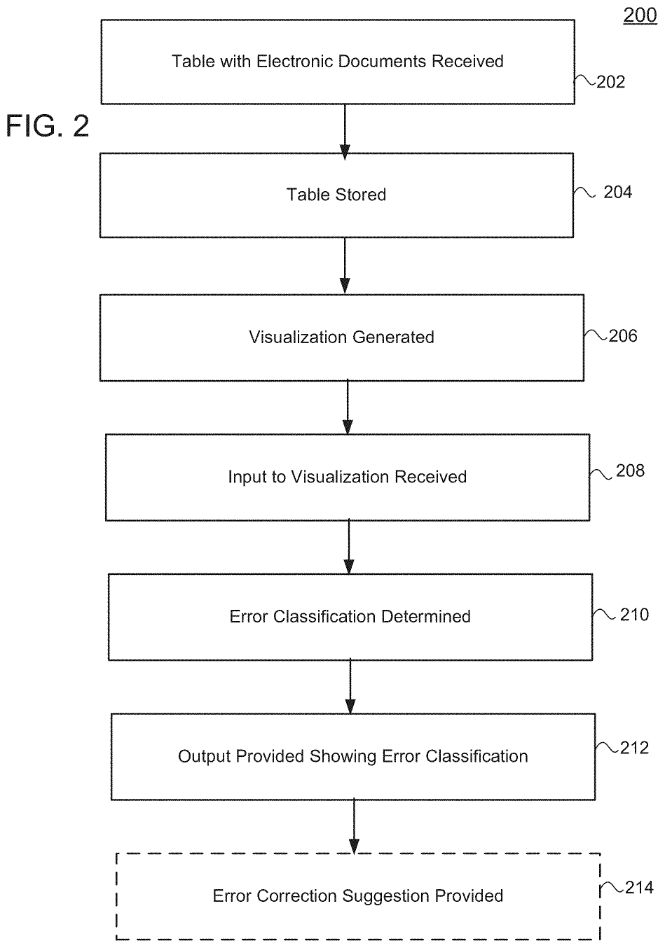

FIG. 2 is a flow diagram of a method 200 according to an embodiment. At 202 a table comprising a first electronic document including a first error, and a second electronic document including a second error, is received from a data source.

At 204, the table is stored in a non-transitory computer readable storage medium. At 206, a non-table visualization is generated depicting the first electronic document and the first error, and the second electronic document and the second error.

At 208, an input to the non-table visualization is received. At 210, in response to the input an error classification is determined for the first error and to the second error.

At 212 an output is provided that shows: the first electronic document, the first error, and the error classification, and the second electronic document, the second error, and the error classification.

Optionally, further processing may take place for electronic document handling. For example, at 214 a suggestion of a solution for correction of the classified error may be provided.

Further details regarding electronic document monitoring, visualization, and error handing according to embodiments, are now provided in connection with the following example.

### Example

As mentioned above, this specific example relates to the SAP DC electronic document handling framework, which is available from SAP SE of Walldorf, Germany. In particular, the SAP DC framework is a global solution to address local requirements mandating the submission of electronic documents to authorities or business partners. This Document Compliance framework is configured to operate in conjunction with the SAP HANA in-memory database, which is available from SAP S/4HANA.

The SAP DC framework comprises two following two main components. First, the eDocument Cockpit application is provided on S/4HANA. The eDocument Cockpit application can help to generate eInvoices from other connected applications. Examples include ERP Sales and Distribution (SD) billing, or from Financial Accounting (FI) AR documents.

A second component of the SAP DC framework is the eInvoice communication service. This eInvoice communication service is provided on the SAP Cloud Platform.

The eDocument Cockpit is a backend application to generate and mange electronic documents—SAP ERP Central Component (ECC), S/4HANA on-premise, and S/4HANA Cloud edition.

As used herein, an abbreviation for electronic document is eDocument. This refers to various kinds of electronic documents (e.g., invoices, delivery notes, and others) that are exchanged with authorities and business partners in the SAP DC solution.

This particular example relates to electronic document handling in compliance with national laws of the nation of South Korea. Specifically, South Korea dictates enterprises perform the following scenario-specific electronic document handling process flows:

send customer tax invoices,

obtain supplier tax invoices,

send self-billing tax invoices, and

obtain self-billing tax invoices.

In order to achieve the efficient monitoring, visualization, and error identification and error correction of electronic documents in compliance with applicable laws as well as internal regulations, eDocument Assistant was created and implemented by SAP SE. This eDocument Assistant is a lightweight, intelligent application that is designed to operate in conjunction with the Document Compliance solution on SAP S/4HANA.

Addition of the eDocument Assistant according to embodiments, allows for the identification and efficient resolution of eDocument issues, using automated error classification and intelligent solution recommendation. The eDocument Assistant helps enterprises remain in compliance in terms of electronic documents, improves process efficiency, and reduces costs.

Electronic document monitoring features offered by the eDocument Assistant, are now described. At least four types of document errors may exist.

A “missing mandatory information” is an internal error checked by eDocument Cockpit. Specifically, when submitting the eInvoice, the eDocument Cockpit checks the mandatory information and produces an error when any such information is missing. This error type arises mainly based upon operation of the eDocument Cockpit upon an original document, but could also arise where a user has neglected to fill completely fill out the original document.

The “process action error” is an internal error checked by eDocument Cockpit. In particular, the eDocument has lifecycle management (e.g., defined for each eDocument type) that defines which actions can proceed and the execution sequence. For example, for a South Korean tax invoice, the lifecycle may be defined by the actions: create->edit->submit->display pdf->get status. Here, if a user displays pdf before submitting, an error of the process action type will be raised.

Another type of internal error is the “communication error”. Since eDocuments need to be transformed to be received by the tax authority (either directly at the tax authority platform or by an authorized 3^{rd} party service provider), there might arise certain communication errors like authorization error, connection error, etc. If the target receiving server is down or the authorization check is incorrect, a connection error may pop up.

Still another error type is the “response error from external system”. This is an external error. When the eDocument is received a target system (of the tax authority itself or of a 3rd party authorized thereby), the target systems validate the received eInvoice and returns error response messages if applicable.

Given these various (internal, external) error types, in addition to the traditional table view offered by the eDocument Cockpit, the eDocument Assistant further provides a flow chart view to aid in visualizing process flow(s) for each scenario.

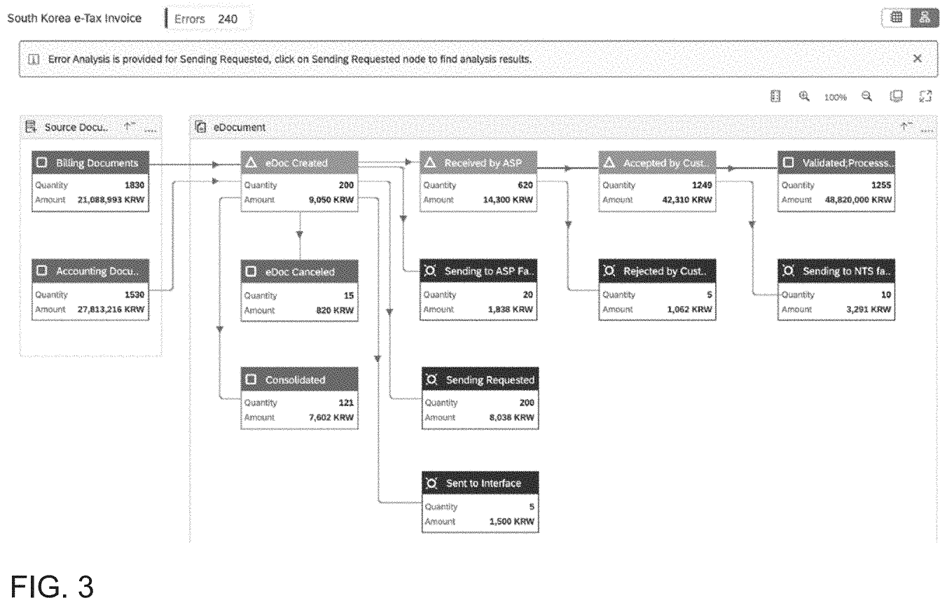

For purposes of illustration, FIG. 3 shows a screen shot of this flow chart view according to an example. This exemplary flow chart view shows an eDocument lifecycle for an Electronic tax (eTax) Invoice scenario in a manner compliant with South Korea law.

In particular, this example shows a process flow of document creation for validation by the tax authorities. Here, the eDocument Assistant supplements the function of the eDocument Cockpit to allow grouping of eDocuments according to process status. In addition, the eDocument Assistant calculates the total number of eDocuments with a specific process status (e.g., indicated by color and/or a specific icon) and the total quantity.

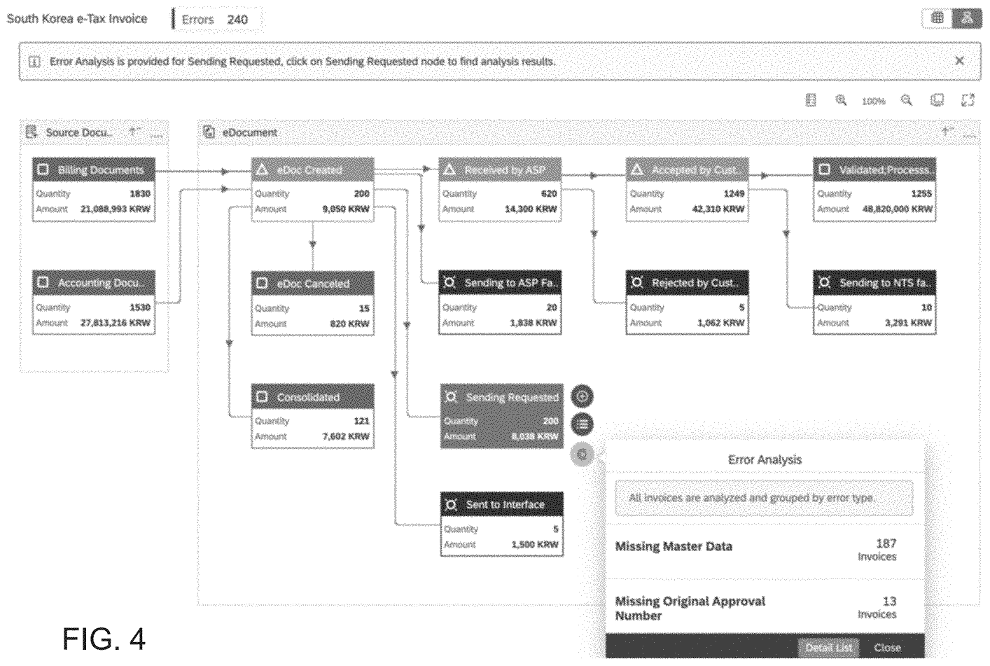

The eDocument Assistant may provide a user with an automated classification function. Specifically, as shown in the screen shot of FIG. 4, the eDocument Assistant classifies eDocuments with errors by analyzing available data sources. These data sources can include but are not limited to:

logs,

error messages, and

responses from business partners and legal authorities.

At least two kinds of error may exist. These error types may comprise internal errors and external errors.

Internal errors occur in SAP systems. External errors usually come from business partners or third parties (e.g., government agencies or authorized agents thereof).

The eDocument Assistant analyzes errors with different methods. It then classifies error documents into categories (e.g., missing master data; missing approval number).

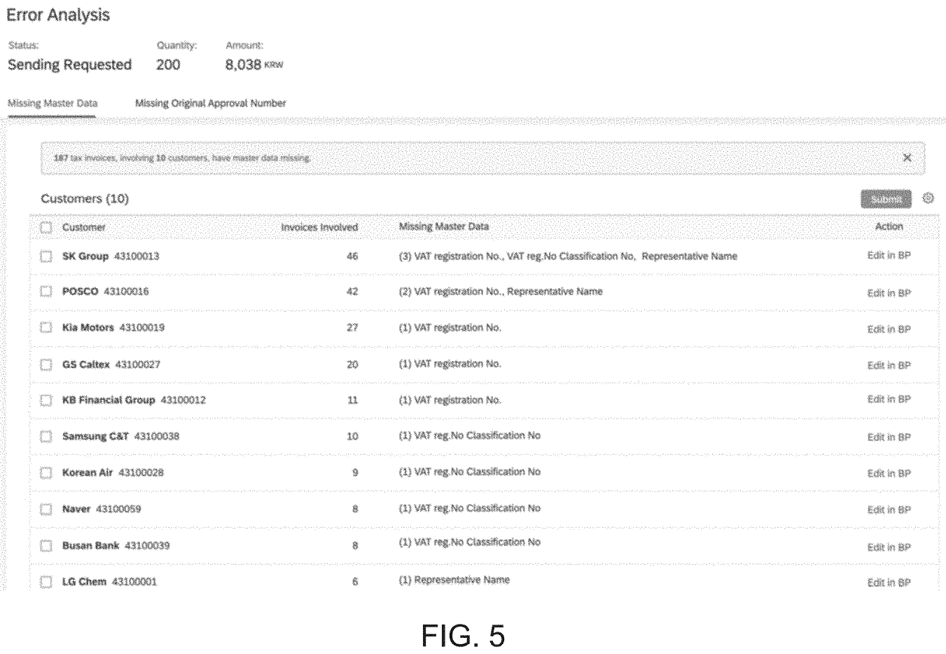

Error categories are described to the user in an understandable way that is not overly technical in nature. Users can simply go into each category to check a list of documents with the same error. Then, they can handle the documents with the same error all at once. For example, as shown in FIG. 5, for the error classification “missing master data”, the eDocument Assistant can determine the customers who have master data missing from their electronic documents.

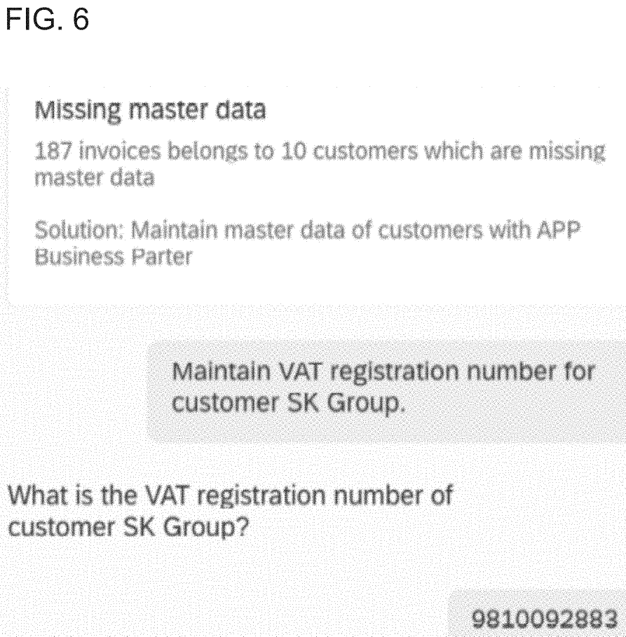

In addition to identifying errors and allowing the handling of electronic documents en masse, the exemplary eDocument Assistant embodiment can provide recommendations to users for resolving those errors. Specifically, as shown in the screen shot of FIG. 6, the eDocument Assistant can tell users directly that they should enter the missing master data for specific customers. The eDocument Assistant can leverage existing features (such as the SAP Leonardo Conversational AI; the SAP CoPilot bot service) in order to provide a chat service to guide users on how to solve a problem.

The eDocument Assistant provides users with the customer links, so that they can navigate to the Business Partner (BP) application and add missing master data quickly and easily. This is depicted by the “Edit in BP” link in FIG. 5. Users can also choose to ask SAP CoPilot for more guidance or automated operations.

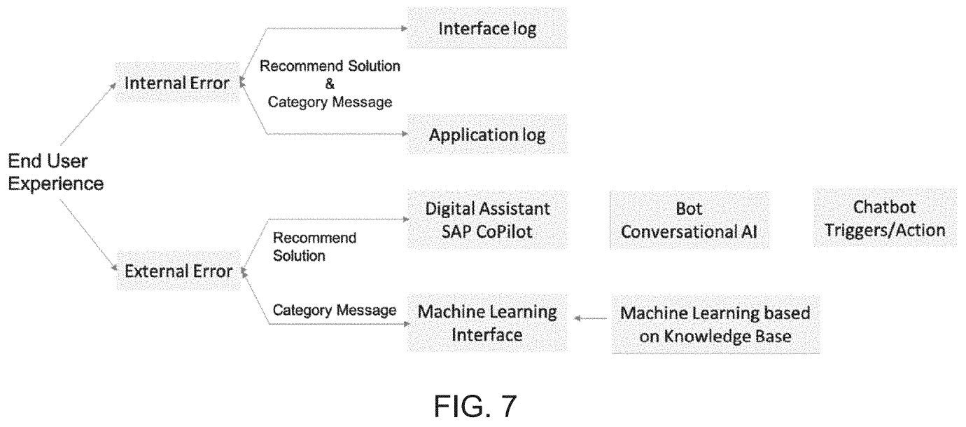

Exemplary embodiments of procedures for performing error analysis, are now described. Here, internal and external error types may be handled differently. This is shown in the simplified flow diagram of FIG. 7, which offers an error analysis overview.

Specifically, internal errors may occur during eDocument checks in the SAP system. Such internal errors are analyzed and classified using the Core Data Services (CDS) view technology. The results are then sent to the UI via oData.

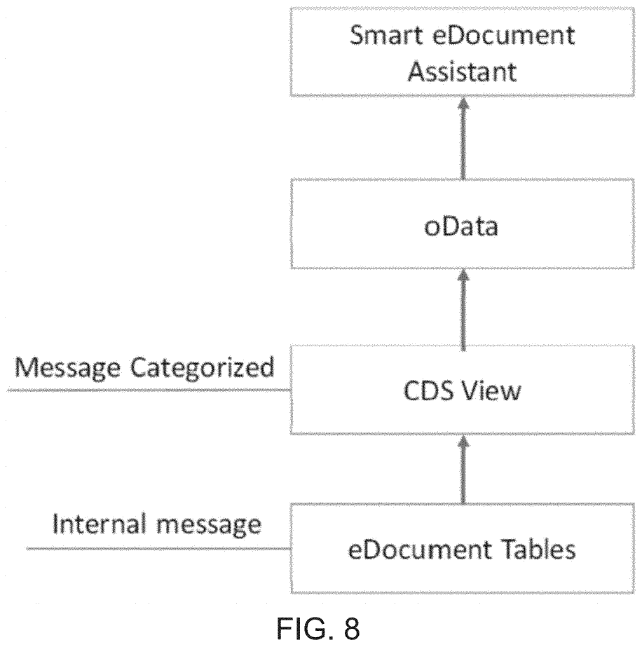

Logs for internal errors are stored in the application log or the interface log. As shown in the exemplary simplified workflow for dealing with eDocument error logs of FIG. 8, these two (application, interface) log types are also handled differently.

Specifically, the application log is a general log for eDocuments. The interface log from the SAP Application Interface Framework (AIF) is a special application log in the eDocument Framework, which records errors occurring during processing by SAP.

The application interface framework according to this exemplary embodiment, is now described. For the application log, we use the “sub-object” method to classify errors.

The application log has country-specific application categories. For example, the application category for South Korea is EDOC_KR, but there is no sub-object.

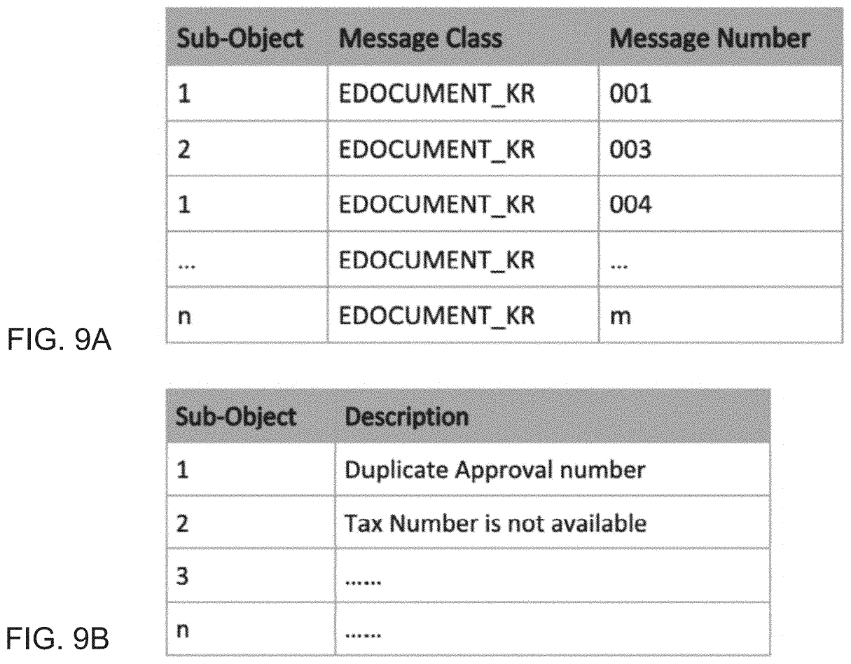

Accordingly, error messages for South Korea are classified as shown in the tables of FIGS. 9A-9B. The table of FIG. 9A allows classifying error messages for South Korea with the sub-object method. FIG. 9B is a table with description texts of sub-objects.

For the interface log, we use the “error type” method to classify errors. The interface log is a special application log with the application category: /AIF/LOG.

The “sub-object” method is not used to classify errors in SAP Application Interface Framework. Further information may be obtained from tables of the eDocument Framework and SAP Application Interface Framework.

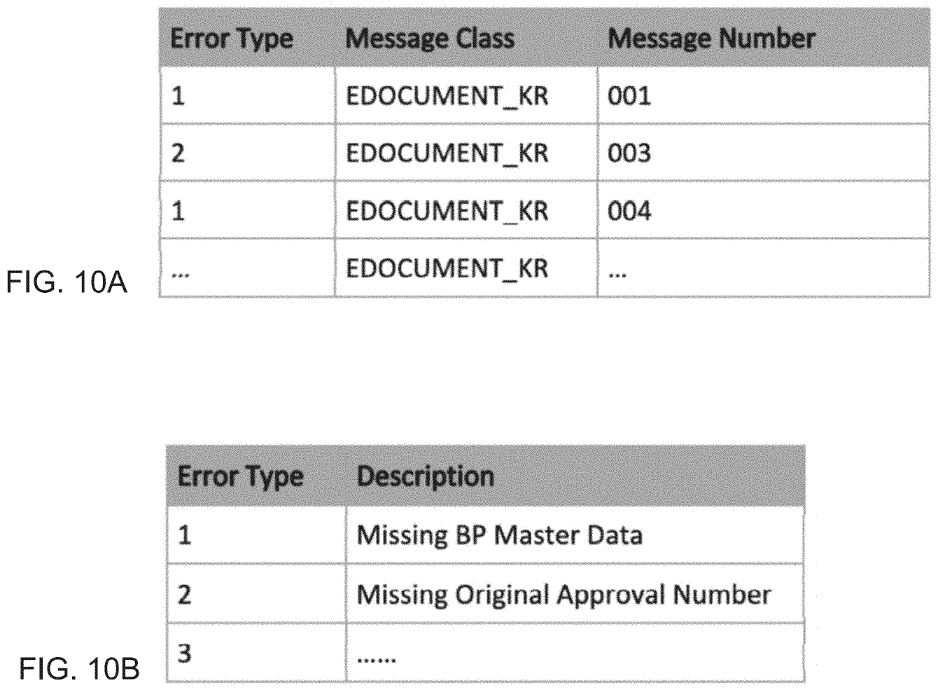

FIG. 10A shows a table for use in classifying error messages for South Korea using the “error type” method. FIG. 10B is a table with description texts of error types.

Analysis of external errors according to this embodiment, are now described. External errors are usually from business partners or tax authorities.

Consider for example, a third party authorized by the South Korean tax authority to receive documents for submission. That third party may communicate messages indicating external errors during document check and validation.

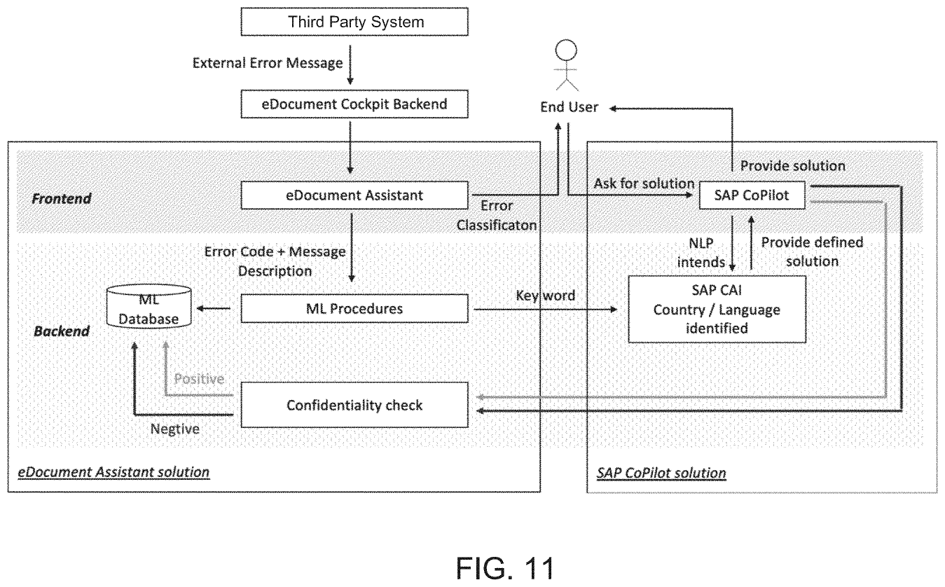

Accordingly, this exemplary embodiment uses SAP CoPilot and SAP Leonardo Conversational AI to guide users on how to deal with external errors. FIG. 11 shows a simplified view of an architecture for performing analysis of external errors. The SAP CoPilot application may utilize the SAP Conversational AI (CAI) feature.

Here, this embodiment consumes Natural Language Processing (NLP) technology from the NLP SAP Leonardo Intelligent service. The Machine Learning (ML) database is also constructed in SAP Leonardo.

For the NLP procedure, this exemplary embodiment uses letter frequency from an external message to generate and store key words of messages as a learning process. CAI provides bot training to analyze text inputs and a bot connector to connect with the eDocument Assistant solution.

Through the chatbot on the interface, users can provide oral feedback. CAI can also provide bot analytics to train the data from user's feedback and improve result accuracy.

In this particular exemplary embodiment, for the machine learning procedure performed by the eDocument Assistant, we use latent Dirichlet allocation (LDA)+Topic Word Embedding (TWE) to analyze the external error messages.

This example uses letter frequency from external message(s) to generate and store key word of messages as a learning process. Consider receiving ‘m’ as external messages. If every word in our existing internal database is theme ‘z’, then we generate the key word ‘w’ on the existing theme.

LDA is used to define the importance of the word in message. With p(z|m) being the probability of generating theme z in message ‘m’, the probability of generating word in theme is p(w|z). Taking the external message ‘m’, the probability of generating key word w is as shown below:

$$p ( w \vert m ) = {\sum }_{z}^{Z} p ( w , z \vert m ) = {\sum }_{z}^{Z} p ( w \vert m , z ) p ( z \vert m ) = {\sum }_{z}^{Z} p ( w \vert z ) p ( z \vert m )$$

Similar to LDA, we use TWE to obtain similarity of word with theme, as we may lose the word not so frequently appearing. This produces:

$$Similarity ( w , m ) = {\sum }_{z}^{Z} cos ( \vec{{v}_{m}} , \vec{{v}_{z}} ) p ( z \vert m )$$

Here \vec{v_{w}} indicates that we use TWE to get the word vector, and \vec{v_{z}} for the theme vector. They are in the same vector space.

We use cosine similarity to calculate the similarity of the word and the theme. Then, we compare two rates to generate most possible key words for the message. We use the theme to get the related solutions of the messages.

Embodiments may offer a number of possible benefits. For example, this example combines:

(i) a data model applied to internal errors,
(ii) a pre-trained ML model for solving external errors in solutions specialized in the exchange of structured documents such as SAP Document Compliance, and
(iii) a classification method for making such errors actionable by users.

The exemplary eDocument Assistant embodiment is readily integrated with the SAP Document Compliance solution on SAP S/4HANA. It provides an intelligent user experience to free end users from complex manual operations, thus reducing the costs of custom development and improving efficiency in error handling.

For SAP, providing the eDocument Assistant can significantly improve the user experience and reduce the call rate of SAP S/4HANA.

Returning now to FIG. 1, there the particular embodiment is depicted with the engine responsible for visualization, error classification, and correction solution suggestion as being located outside of the database storing the electronic document corpus. However, this is not required.

Rather, alternative embodiments could leverage the processing power of an in-memory database engine (e.g., the in-memory database engine of the HANA in-memory database), in order to perform various functions.

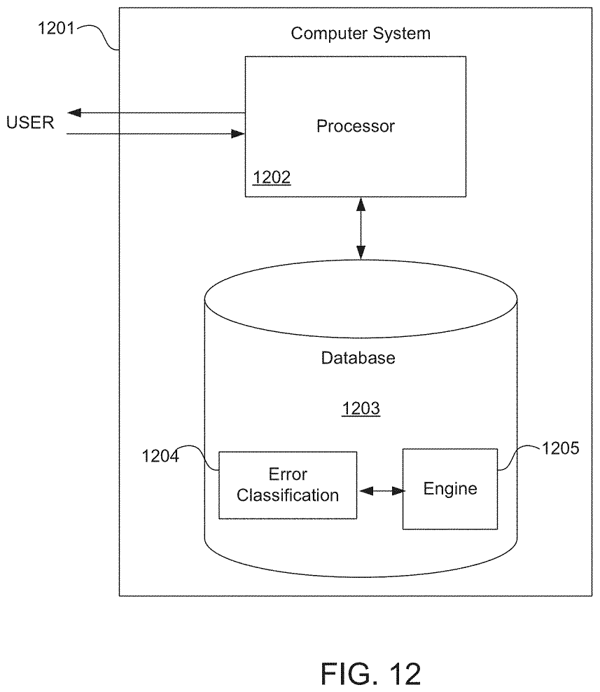

Thus FIG. 12 illustrates hardware of a special purpose computing machine configured to implement document handling according to an embodiment. In particular, computer system 1201 comprises a processor 1202 that is in electronic communication with a non-transitory computer-readable storage medium comprising a database 1203. This computer-readable storage medium has stored thereon code 1205 corresponding to an engine. Code 1204 corresponds to an error classification. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

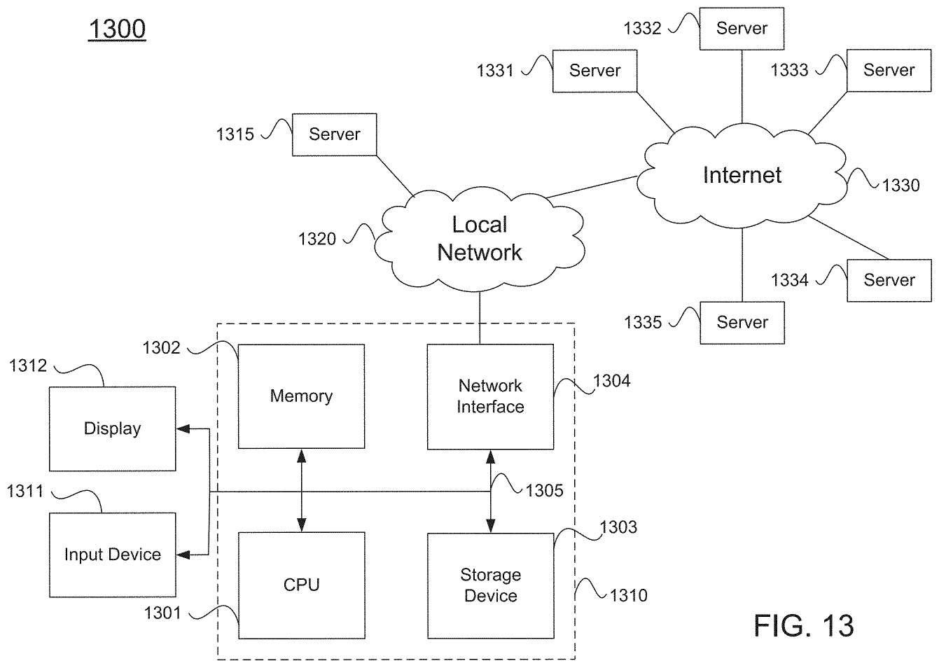

An example computer system 1300 is illustrated in FIG. 13. Computer system 1310 includes a bus 1305 or other communication mechanism for communicating information, and a processor 1301 coupled with bus 1305 for processing information. Computer system 1310 also includes a memory 1302 coupled to bus 1305 for storing information and instructions to be executed by processor 1301, including information and instructions for performing the techniques described above, for example. This memory may also be used for storing variables or other intermediate information during execution of instructions to be executed by processor 1301. Possible implementations of this memory may be, but are not limited to, random access memory (RAM), read only memory (ROM), or both. A storage device 1303 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1303 may include source code, binary code, or software files for performing the techniques above, for example. Storage device and memory are both examples of computer readable mediums.

Computer system 1310 may be coupled via bus 1305 to a display 1312, such as a cathode ray tube (CRT) or liquid crystal display (LCD), for displaying information to a computer user. An input device 1311 such as a keyboard and/or mouse is coupled to bus 1305 for communicating information and command selections from the user to processor 1301. The combination of these components allows the user to communicate with the system. In some systems, bus 1305 may be divided into multiple specialized buses.

Computer system 1310 also includes a network interface 1304 coupled with bus 1305. Network interface 1304 may provide two-way data communication between computer system 1310 and the local network 1320. The network interface 1304 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1304 sends and receives electrical, electromagnetic, or optical signals that carry digital data streams representing various types of information.

Computer system 1310 can send and receive information, including messages or other interface actions, through the network interface 1304 across a local network 1320, an Intranet, or the Internet 1330. For a local network, computer system 1310 may communicate with a plurality of other computer machines, such as server 1315. Accordingly, computer system 1310 and server computer systems represented by server 1315 may form a cloud computing network, which may be programmed with processes described herein. In the Internet example, software components or services may reside on multiple different computer systems 1310 or servers 1331-1335 across the network. The processes described above may be implemented on one or more servers, for example. A server 1331 may transmit actions or messages from one component, through Internet 1330, local network 1320, and network interface 1304 to a component on computer system 1310. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving from a data source, a table comprising a first electronic document including a first error, and a second electronic document including a second error;
generating a non-table visualization depicting,
the first electronic document and the first error, and
the second electronic document and the second error;
receiving an input to the non-table visualization;
in response to the input, determining an error classification for the first error and for the second error;
storing the error classification in a non-transitory computer readable storage medium; and
provide an output showing,
the first electronic document, the first error, and the error classification, and
the second electronic document, the second error, and the error classification.

2. A method as in claim 1 wherein the non-table visualization comprises a flow diagram based upon an execution sequence of the first electronic document and of the second electronic document.

3. A method as in claim 1 further comprising:
training a model with stored error correction data;
inputting the first error and the second error to the model to output a solution for correcting the first error and the second error; and
communicating the solution to a user.

4. A method as in claim 3 wherein:
the model comprises a theme and a keyword; and
the training comprises determining a similarity of the theme and the keyword.

5. A method as in claim 3 further comprising:
receiving an acceptance of the solution; and
implementing the solution to correct the first error and the second error.

6. A method as in claim 1 wherein the error classification reflects an internal error arising from a requirement of the data source.

7. A method as in claim 1 wherein the error classification reflects an external error originating from a requirement of other than the data source.

8. A method as in claim 1 wherein:
the non-transitory computer readable storage medium comprises an in-memory database; and
generating the visualization is performed by an in-memory database engine of the in-memory database.

9. A non-transitory computer readable storage medium embodying a computer program for performing a method, said method comprising:
receiving from a data source, a table comprising a first electronic document including a first error, and a second electronic document including a second error;
generating a flow chart visualization from an execution sequence of the first electronic document and of the second electronic document, the flow chart visualization depicting,
the first electronic document and the first error, and
the second electronic document and the second error;
receiving an input to the flow chart visualization;
in response to the input, determining an error classification for the first error and for the second error;
storing the error classification in a non-transitory computer readable storage medium; and
provide an output showing,
the first electronic document, the first error, and the error classification, and
the second electronic document, the second error, and the error classification.

10. A non-transitory computer readable storage medium as in claim 9 wherein the method further comprises:
training a model with stored error correction data;
inputting the first error and the second error to the model to output a solution for correcting the first error and the second error;
communicating the solution to a user;
receiving an acceptance of the solution; and
implementing the solution to correct the first error and the second error.

11. A non-transitory computer readable storage medium as in claim 10 wherein:
the model comprises a theme and a keyword; and
the training comprises determining a similarity of the theme and the keyword.

12. A non-transitory computer readable storage medium as in claim 9 wherein the error classification reflects an internal error originating from a requirement of the data source.

13. A non-transitory computer readable storage medium as in claim 9 wherein the error classification reflects an external error originating from a requirement of other than the data source.
